(19) United States
(12) Patent Application Publication
(10) Pub. No.: US 2011/0252675 A1
(43) Pub. Date: Oct. 20, 2011

(54) ACTIVE LICENSE PLATE

(75) Inventor: Freeman Thomas, Laguna Beach, CA (US)

(73) Assignee: FORD GLOBAL TECHNOLOGIES, LLC, Dearborn, MI (US)

(21) Appl. No.: 12/763,598

(22) Filed: Apr. 20, 2010

(51) Int. Cl. B60R 13/10

(52) U.S. Cl. 40/205

(57) ABSTRACT

A license plate display system for a vehicle includes a license plate with a series of indicia on a base. One of the indicia and the base are one of translucent and transparent, and the other of the base and the indicia being opaque. The license plate display system also includes an array of light emitting diodes (LEDs), with the array containing at least one LED of a first color and at least one LED of a second color. The array transmits light to the license plate.

### TECHNICAL FIELD

Various embodiments of the invention relate to a license plate assembly for use with a vehicle.

### BACKGROUND ART

It is known in the art to provide vehicles with license plates. License plates have been used since the late 1800s and early 1900s on vehicles, beginning in Europe the United States, and Canada, and now are generally used world-wide. License plates are known as registration plates, vehicle registration plates, number plates, tags, or others as are known in the art.

The license plate provides identification of the vehicle to other drivers, passenger, pedestrians, law enforcement, and the general public. License plates are used on the rear bumper or rear facing portion of a vehicle such as an automobile or truck, or on a trailer for attachment to a vehicle. A license plate may also be attached to a front bumper, or a front portion of the vehicle.

License plates commonly have a numeric or alphanumeric code, and may be personalized by the vehicle owner in what has come to be known as a “vanity plate”. The code on the license plate may be unique within a country, or within a state or province. License plates may expire after a specified period of time, often a year, at which point they are renewed or replaced. If the license plate is renewed, a decal may be placed on the plate or elsewhere on the vehicle to indicate the new expiration date of the license plate.

### SUMMARY

In one embodiment, a license plate display system for a vehicle is provided with a license plate having a series of indicia on a base, one of the indicia and the base being one of translucent and transparent, the other of the base and the indicia being opaque. The license plate display system also has an array of light emitting diodes (LEDs), with the array containing at least one LED of a first color and at least one LED of a second color. The array is for transmitting light to the license plate.

A further embodiment provides a controller for selectively illuminating at least one of the LEDs in the array.

An even further embodiment provides a vehicle security system to provide an input to the controller.

A further embodiment provides a vehicle electronic control module to provide an input to the controller.

An even further embodiment provides a receiver for a wireless data transmission to provide an input to the controller.

A further embodiment discloses that the first color is white.

An even further embodiment discloses that the second color is chosen from the group consisting of red, blue, amber, and green.

A further embodiment discloses that the controller illuminates the white LED to illuminate the license plate during normal vehicle operation.

An even further embodiment discloses that the controller illuminates the colored LED to illuminate the license plate during a warning signal provided as an input to the controller.

A further embodiment discloses that the warning signal is based on at least one of a traffic alert, a stolen vehicle report, a prior vehicle violation, and an emergency broadcast.

An even further embodiment discloses that the one of the base and the indicia is transparent.

A further embodiment provides a diffuser oriented between the plate and the at least one light emitting diode array.

A further embodiment discloses that the base is one of transparent and translucent, and the indicia are opaque. The embodiment discloses that the base is illuminated by the LED of the first color during low ambient light operating conditions. The embodiment also discloses that the base is illuminated by the LED of the second color during a warning input to the controller during operating conditions.

In another embodiment, a lighting system for a license plate display is provided with a bumper unit for attachment to a vehicle, with the bumper unit defining an aperture sized to receive a partially transparent license plate. The lighting system also has an array of light emitting diodes (LEDs), with the array having at least one white LED and at least one colored LED, and a diffuser arranged between the array and the aperture for diffusing light emitted by the array. The lighting system has a controller for selectively illuminating at least one of the LEDs in the array based on an input from at least one of a vehicle security system, a vehicle electronic control module, and a receiver for a wireless data transmission.

A further embodiment discloses that the controller illuminates the at least one white LED when a normal operations input is received by the controller.

An even further embodiment discloses that the controller illuminates the at least one colored LED when a warning input is received by the controller.

In yet another embodiment, a lighting system for a license plate is provided with an array of light emitting diodes (LEDs), the array having at least one white LED and at least one colored LED, and a controller for selectively illuminating at least one of the LEDs in the array. Light from the LED array reflects from a partially reflective license plate to provide information.

A further embodiment discloses that an input is provided to the controller by at least one of a vehicle security system, a vehicle electronic control module, and a receiver for a wireless data transmission.

An even further embodiment discloses that the controller selectively illuminates the at least one white LED when a normal operations input is received by the controller.

A further embodiment discloses that the controller selectively illuminates the at least one colored LED when a warning input is received by the controller.

### BRIEF DESCRIPTION OF THE DRAWINGS

FIG. 1 is a perspective view of a vehicle with an active license plate according to an embodiment;

FIG. 2 is an exploded schematic view of an active license plate and bumper according to another embodiment; and

FIG. 3 is a schematic of an active license plate system according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

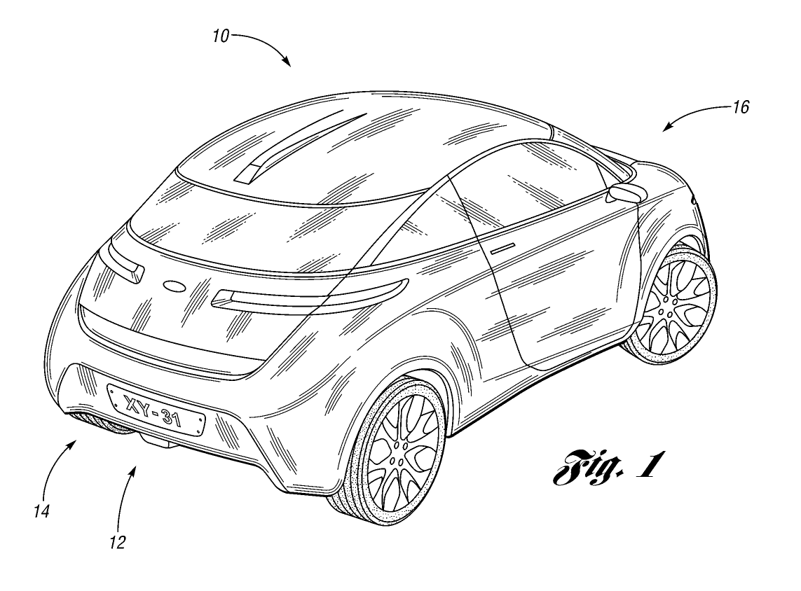

FIG. 1 shows a vehicle 10 having an active license plate system 12. The license plate system 12 is shown attached to the rear bumper panel 14 of the vehicle 10, although it could also be attached to a front bumper 16, another front or rear portion of the vehicle 10, or a trailer. The license plate system 12 may be illuminated in different colors to indicate information to other drivers, passengers, law enforcement, pedestrians, or the general public.

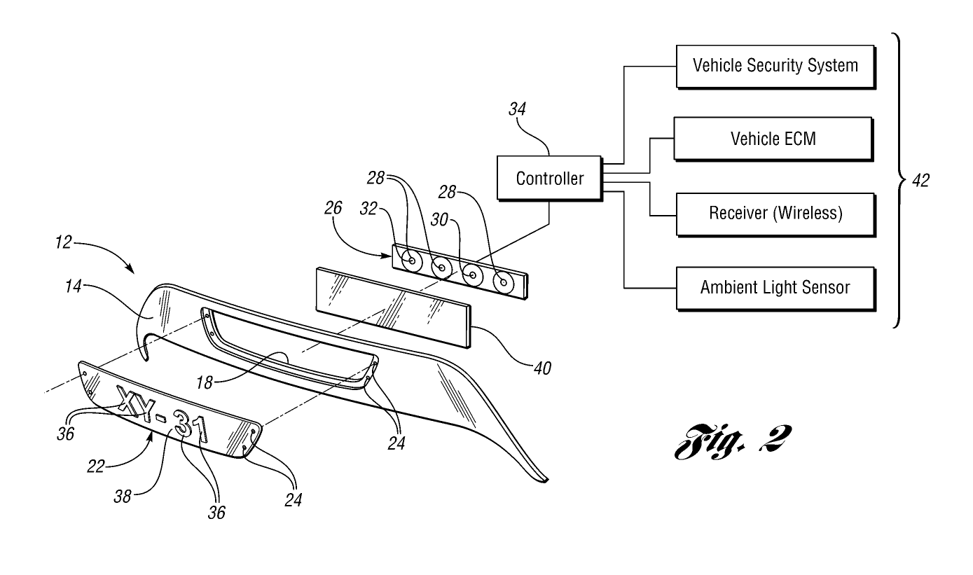

FIG. 2 shows an embodiment of the active license plate system 12. The bumper panel 14 has an aperture 18, which may have a flange 20 surrounding the aperture 18. A license plate 22 may be placed over the aperture 18 and the flange 20. The license plate 22 is fastened to the bumper panel 14 using bolts, snap fittings, or the like. The plate 22 may be flush mounted with the bumper panel 14. The flange 22 and the license plate 20 may have corresponding apertures 24 or the like for use in attaching the plate 22 to the bumper panel 14.

A light emitting diode (LED) array 26 is arranged such that light may be transmitted through a portion of the license plate 22 to illuminate the plate 22 from an interior side of the plate 22. The LED array 26 may be made up of multiple individual LEDs 28, where some of the LEDs 28 are different colors. For example, there may be a white LED and a colored LEDs. The use of multiple LEDS 28 of several different colors is also contemplated. The colored LEDs may be red, blue, green, amber, infrared, or any other color of LED as is known in the art. Alternatively the LEDs 28 may all be white in color, with some of the LEDs 28 having a colored transparent cap to provide red, blue, green, amber, or other colored light. FIG. 2 includes a white LED 30 and a colored LED 32 in the array 26. A controller 34 is connected to the LEDs 28 in the array 26 to control which of the LEDs 28 are illuminated and unilluminated.

The license plate 22 has a series of indicia 36 on a base 38. The series of indicia 36 are the alphanumeric characters or other identifiers for the license plate 22. Several optical configurations are contemplated for the indicia 36 and the base 38 on the license plate 22. Opaque materials are considered to primarily block the transmission of light, while translucent and transparent materials allow the transmission of light through them. Transparent materials allow virtually all of the light to pass through them, for example through a clear acrylic. Translucent materials allow a portion of the light to be transmitted through them, for example with a frosted acrylic.

In one embodiment, the base 38 is opaque light, and the series of indicia 36 is either transparent or translucent, such that the indicia 36 may be illuminated by the LEDs 28 in the array 26. In another embodiment, the indicia 36 are opaque, while the base 38 is transparent or translucent, such that the indicia 36 appear backlit when the LED array 26 is illuminating the plate 22.

Only one LED array 26 may be used with the license plate system 12, as shown in FIG. 2, or multiple arrays 26 may be used. In one embodiment, a diffuser 40 is placed between the array 26 and the plate 22. The diffuser 40 diffuses the light from the LEDs 28 before the light interacts with the plate 22. This may be used when a portion of the plate 22 is transparent to prevent bright spots from individual illuminated LEDs 26 appearing to an observer outside the vehicle 10, which may be a safety consideration. The diffuser 40 may also be used to help evenly distribute light from an LED 28 to more evenly illuminate a portion of the plate 22. The diffuser 40 may also have a beam shaping quality, where it additionally acts as a lens to better direct or distribute the light across the plate 22. The diffuser 40 may have multiple lens shapes designed into the diffuser 40 if multiple LED arrays 26 are being used, or a separate diffuser 40 may be associated with each individual LED array 26.

The controller 34 is electrically connected to the LED array 26, and also to a power supply (not shown). The controller 34 is able to power each LED 28 on for illumination and off for unillumination individually, and may power multiple LEDs 28 simultaneously. The controller 34 includes an integrated circuit and is capable of receiving inputs from multiple sources 42.

Input sources 42 may include the vehicle electronic control module (ECM), the vehicle security system, a wireless data receiver or transceiver, a satellite receiver or transceiver, an ambient light sensor, a cellular receiver, or the like. Based on the input source 42, the controller 34 illuminates a predetermined LED 28, thereby displaying a predetermined color on the plate 22, and may turn other LEDs 28 off.

In one embodiment, the controller 34 turns on a white LED 30 such that the transparent or translucent indicia 36 on the plate 22 are illuminated, while the base 38 remains unilluminated to an outside observer due to its opacity. The indicia 36 appear as white glowing alphanumeric characters. Of course, the base 38 could be the transparent or translucent portion, while the indicia 36 are opaque. The white LED 30, and corresponding white illuminated indicia 36, indicate that that vehicle 10 is in a normal operational mode. A normal operational mode exists when the controller has not received a warning input signal from another source 42 signifying otherwise, and the vehicle 10 is operating in a normal range, potentially as signaled by the vehicle ECM.

In another embodiment, the white LED 30 is only illuminated during a normal operating condition when the ambient light level of the surrounding environment is sufficiently low to make visibility of the plate 22 difficult, such as during twilight and night conditions, in a tunnel or a parking garage, or the like. An ambient light sensor acts as the input source 42 regarding the light level to the controller 34.

The controller 34 may turn off the white LED 30 and illuminate a colored LED 32 based on a warning signal received from an input source 42. For example, the vehicle security system provides a warning input signal to the controller 34 if the vehicle alarm was triggered. The controller 34 also receives a warning input if the plate 22 or vehicle 10 registration had lapsed. A wireless data receiver or transceiver receives signals through cell towers, satellite, local area networks, or others as are known in the art that provide warning inputs to the controller 34. Examples of reasons for a warning input signal include stolen vehicle reports, traffic reports, emergency broadcast responses, or the like.

In one embodiment, a blue LED 28 is illuminated by the controller 34, thereby illuminating the indicia 36 as blue, when a warning signal based on a stolen vehicle report for the vehicle 10, an expired vehicle registration, or an alert from the vehicle security system is received. A transceiver may also be used to receive a warning signal regarding the vehicle 10 being stolen, or the like, by the owner dialing in an alert to a cellular transceiver on-board the vehicle 10. This may alert law enforcement, or the general public, that the vehicle 10 is distress.

An amber LED 28 is illuminated when an emergency broadcast response is received as a warning signal by the controller 34, thereby illuminating the indicia 36 as amber or yellow. An emergency broadcast includes a missing person or stolen child report for example.

A red LED 28 is illuminated when a warning signal is received by the controller 34, thereby illuminating the indicia 36 as red, when a traffic ahead signal, construction ahead signal, poor weather conditions signal, or poor road conditions ahead signal is received by the wireless data receiver or a transceiver acting as the input 42. The red illuminated plate 22 may alert drivers behind the vehicle 10, and provide advance warning of slowing or stopped traffic, thereby assisting in reducing rear-end collisions, and the like.

Of course, a colored LED 32 may also be used to signify normal operations, while a white LED 30 is associated with a warning input. Also, use of any of the white or colored LEDs 28 may be associated with any of the normal or warning signals. An array 26 may have only one white and one colored LED 28, one white and multiple colored LEDs 28, multiple colored LEDs 28, or any combination thereof.

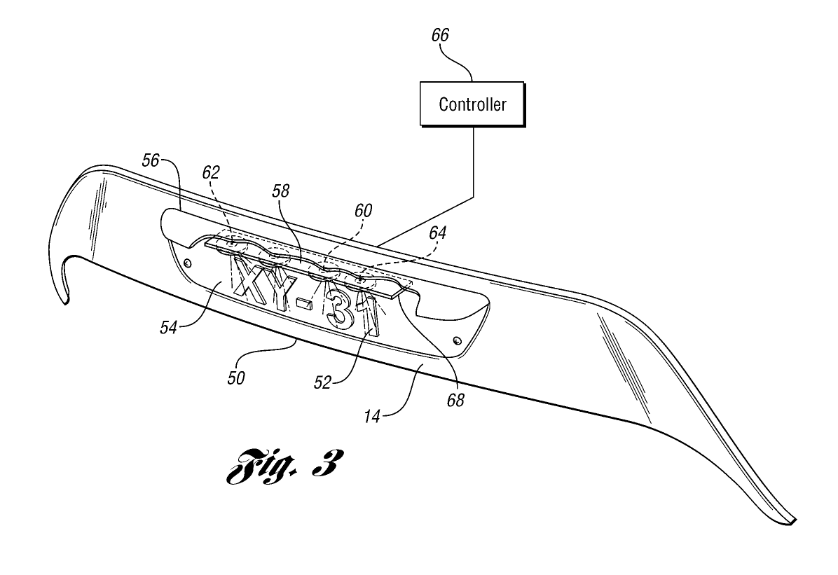

FIG. 3 shows another embodiment of the license plate system 12. The license plate 50 is attached to a bumper panel 14. The license plate 50 has a series of indicia 52 on a base 54. In one embodiment, the indicia 52 are reflective, and the base 54 is generally non-reflective. In another embodiment, the base 54 is reflective, and the indicia 52 are generally non-reflective.

The bumper panel 14 has a lip 56, or other structure, extending longitudinally beyond the plate 50, and located above the plate 50 as shown, although it may also be located below the plate 50. The lip 56 provides a housing for an LED array 58 having multiple LEDs 60. The LEDs 60 are different colors. For example, the LED array 58 may have, for example with a white LED 62, a first colored LED 64, and a second colored LED 66. The colored LEDs 60 may be red, blue, green, amber, or others as is known in the art. The LEDs 60 in the array 58 are connected to a controller 66, which selectively illuminates at least one of the LEDs 60 based on an input to the controller 66.

Light emitted from an illuminated LED 60 is directed towards the plate 50, where it reflects off of the reflective indicia 52 or reflective base 54. A least a portion of the reflected light from the plate 50 then travels rearward of the vehicle 10 to provide information to other drivers, law enforcement, pedestrians, or the general public. In one embodiment, the reflective surface includes directed reflection such as microreplicated prismatic surfaces, or the like to more efficiently receive light from the LEDs 60 and reflect the light rearwards. In another embodiment, a prismatic lens 68 or the like may be placed adjacent to the LED array 58 to better direct the light emitted from the LED array 58 to the plate 50.

The controller 66 illuminates the various LEDs 60 based on a normal operations input or a warning signal as described previously.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed:

1. A license plate display system for a vehicle comprising:
a license plate having a series of indicia on a base, one of the indicia and the base being one of translucent and transparent, the other of the base and the indicia being opaque; and
an array of light emitting diodes (LEDs), the array containing at least one LED of a first color and at least one LED of a second color, the array for transmitting light to the license plate.

2. The license plate display system of claim 1 further comprising a controller for selectively illuminating at least one of the LEDs in the array.

3. The license plate display system of claim 2 further comprising a vehicle security system to provide an input to the controller.

4. The license plate display system of claim 2 further comprising a vehicle electronic control module to provide an input to the controller.

5. The license plate display system of claim 2 further comprising a receiver for a wireless data transmission to provide an input to the controller.

6. The license plate display system of claim 2 wherein the first color is white.

7. The license plate display system of claim 6 wherein the second color is chosen from the group consisting of red, blue, amber, and green.

8. The license plate display system of claim 7 wherein the controller illuminates the white LED to illuminate the license plate during normal vehicle operation.

9. The license plate display system of claim 7 wherein the controller illuminates the colored LED to illuminate the license plate during a warning signal provided as an input to the controller.

10. The license plate display system of claim 9 wherein the warning signal is based on at least one of a traffic alert, a stolen vehicle report, and an emergency broadcast.

11. The license plate display system of claim 1 wherein the one of the base and the indicia is transparent.

12. The license plate display system of claim 11 further comprising a diffuser oriented between the plate and the at least one light emitting diode array.

13. The license plate display system of claim 1 wherein the base is one of transparent and translucent, and the indicia are opaque;
wherein the base is illuminated by the LED of the first color during low ambient light operating conditions; and
wherein the base is illuminated by the LED of the second color during a warning input to the controller during operating conditions.

14. A lighting system for a license plate display comprising:
a bumper unit for attachment to a vehicle, the bumper unit defining an aperture sized to receive a partially transparent license plate;
an array of light emitting diodes (LEDs), the array having at least one white LED and at least one colored LED;
a diffuser arranged between the array and the aperture for diffusing light emitted by the array; and
a controller for selectively illuminating at least one of the LEDs in the array based on an input from at least one of a vehicle security system, a vehicle electronic control module, and a receiver for a wireless data transmission.

15. The lighting system of claim 14 wherein the controller illuminates the at least one white LED when a normal operations input is received by the controller.

16. The lighting system of claim 14 wherein the controller illuminates the at least one colored LED when a warning input is received by the controller.

17. A lighting system for a license plate comprising:
an array of light emitting diodes (LEDs), the array having at least one white LED and at least one colored LED; and
a controller for selectively illuminating at least one of the LEDs in the array;
wherein light from the LED array reflects from a partially reflective license plate to provide information.

18. The lighting system of claim 17 wherein an input is provided to the controller by at least one of a vehicle security system, a vehicle electronic control module, and a receiver for a wireless data transmission.

19. The lighting system of claim 18 wherein the controller selectively illuminates the at least one white LED when a normal operations input is received by the controller.

20. The lighting system of claim 18 wherein the controller selectively illuminates the at least one colored LED when a warning input is received by the controller.
